(19) United States
(12) Patent Application Publication
(10) Pub. No.: US 2010/0272337 A1
(43) Pub. Date: Oct. 28, 2010

(54) MAGNETIC RESONANCE IMAGING APPARATUS

(76) Inventors: Toru Shirai, Kawasaki (JP); Yoshitaka Bito, Kokubunji (JP); Yukari Yamamoto, Kunitachi (JP); Satoshi Hirata, Kodaira (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/741,086

(22) PCT Filed: Jul. 7, 2008
(86) PCT No.: PCT/JP2008/062274

§ 371 Date: May 3, 2010

(30) Foreign Application Priority Data
Nov. 1, 2007 (JP) 2007-284945

(51) Int. Cl. G06K 9/00

(52) U.S. Cl. 382/131

(57) ABSTRACT

While removing signals unnecessary for measuring signals from a metabolite, data required for eddy current correction are obtained in a short period of time. Signals from an unnecessary substance which is not an object of the measurement are removed, and phase data for correcting spectral distortion caused by an eddy current are obtained by a single measurement. Two kinds of frequency-selective pulses of which intensities are adjusted so that the signals from the unnecessary substance should have the same absolute values of intensities and opposite polarities are applied with changing intensities for every phase encoding for at least one axis, and the obtained signals are arranged in a k-space. By removing aliasing of image data obtained from the k-space data, signals from an unnecessary substance are removed, and phase data for eddy current correction are calculated by using a part of the k-space data.

### TECHNICAL FIELD

The present invention relates to a technique for magnetic resonance imaging. In particular, the present invention relates to a technique for MRSI (Magnetic Resonance Spectroscopic Imaging), which images a spatial signal intensity distribution of every metabolite.

### BACKGROUND ART

A magnetic resonance imaging (MRI) apparatus irradiates a radio frequency magnetic field of a specific frequency on a subject placed in a static magnetic field to excite atomic nuclei such as those of hydrogen contained in the subject, and measures magnetic resonance signals generated from the subject to obtain physical and chemical information. The measured magnetic resonance signals exhibit the chemical shift phenomenon, which means that resonant frequencies of molecules slightly differ due to difference in the molecular structures. There are known MRS (Magnetic Resonance Spectroscopy) measurement in which magnetic resonance signals of each molecule (metabolite) are separated by utilizing that phenomenon to obtain a spectrum thereof, and MRSI measurement in which a spatial signal intensity distribution of each metabolite is further imaged.

The major metabolites existing in human bodies and detectable by MRS or MRSI include choline, creatine, N-acetylaspartic acid, lactic acid, and so forth. Measurement of amounts of these metabolites enables stage determination or early diagnosis of metabolic disorders such as cancers. Moreover, it is expected that they also enable non-invasive diagnosis of malignancy of tumors.

Since signals of such metabolites existing in human bodies have a intensity corresponding to only about 1/1000 of that of water molecules, weak signals from the metabolites are buried in the foot of the gigantic peak signal generated by water, and detection thereof is difficult. Therefore, there are methods of suppressing signals unnecessary for the measurement such as those of water in order to measure signals from metabolites. For example, there is a method of preliminarily suppressing unnecessary signals by using a radio frequency (RF) pulse having a frequency band comparable to the frequency band of signals unnecessary for the measurement, and detecting marginal signals of metabolites (refer to, for example, Patent document 1). The method of suppressing signals by pseudo saturation around the resonant frequency band of unnecessary signals is called CHESS (CHEmical Shift Selective) method.

Moreover, in the MRS measurement and the MRSI measurement (MRS/MRSI measurement), an eddy current is generated by a gradient magnetic field applied upon the measurement, and makes the static magnetic field spatially and temporally inhomogeneous. Since the shape of the measured spectrum is distorted due to the inhomogeneity of the static magnetic field, eddy current correction for correcting phases of the spectrum is performed by using phase data (phase values). In the eddy current correction, in order to obtain correct correction values, spatial and temporal phase values are calculated from signals of water having signal intensities larger than those of metabolites, and the correction is carried out by using them (refer to, for example, Non-patent document 1).

Patent document 1: Japanese Patent Unexamined Publication (Kokai) No. 60-168041
Non-patent document 1: Klose U. et al., In Vivo proton spectroscopy in presence of eddy currents, Magnetic Resonance in Medicine, Vol. 14, pp. 26-30 (1990)

### DISCLOSURE OF THE INVENTION

### Problem to be Solved by the Invention

In the MRS/MRSI measurement, signals from water etc. having higher signal intensities compared with those of metabolites are suppressed as unnecessary signals. Therefore, in order to correct influence of an eddy current, it is necessary to obtain water signal data, apart from the main measurement. In MRSI, in particular, in order to obtain spatial distribution of the inhomogeneity of static magnetic field caused by an eddy current, water signal data must be measured for the same number of matrices as that of the MRSI main measurement, and thus the substantial measurement time markedly increases.

The present invention has been made in view of the situation above, and an object of the invention is to provide a technique for removing signals unnecessary for measuring signals of metabolites and, at the same time, obtaining data necessary for the eddy current correction.

### Means to Solve the Problem

According to the present invention, signals from unnecessary substances, which are not objects of the measurement, are removed, and phase data for correcting distortion of the spectrum caused by an eddy current are obtained by a single measurement. Two kinds of frequency-selective pulses of which intensities are adjusted so that they generate signals from an unnecessary substance having the same absolute values of intensities and opposite polarities are applied with changing the intensities in every phase encoding for at least one axis, and the obtained signals are arranged in the k-space. By removing aliasing of the unnecessary signals in the image data obtained by performing Fourier transform on the k-space data, signals from the unnecessary substance are removed, and phase data for eddy current correction are calculated by using a part of the k-space data. Image data are corrected with the calculated phase data to obtain an image.

Specifically, the present invention provides a magnetic resonance imaging apparatus comprising a radio frequency magnetic field pulse irradiation means for irradiating a radio frequency magnetic field pulse on a subject placed in a static magnetic field space, a gradient magnetic field application means for applying a gradient magnetic field for adding spatial information, a detection means for detecting nuclear magnetic resonance signals generated from the subject, a control means for controlling operations of the radio frequency magnetic field pulse irradiation means, the gradient magnetic field application means, and the detection means, and an image reconstruction means for reconstructing an image from the magnetic resonance signals detected by the detection means, wherein the control means controls the operations so as to perform magnetic resonance spectroscopic imaging (MRSI) measurement, executes a pre-pulse sequence for applying a frequency selective pulse for carrying out intensity modulation of only signals from unnecessary substances as unnecessary signals for every phase encoding in the MRSI measurement prior to the MRSI measurement, and arranges the signals detected by the detection means in a measurement space as measured data, and the image reconstruction means comprises a correction data calculation means for calculating data for correction using a part of the measured data arranged in the measurement space, and corrects image data obtained by removing the unnecessary signals from the measured data arranged in the measurement space using the correction data.

### EFFECT OF THE INVENTION

According to the present invention, while removing unnecessary signals in order to measure signals from metabolites, data required for eddy current correction can be simultaneously obtained.

### BRIEF DESCRIPTION OF THE DRAWINGS

FIG. 1A shows an external view of an MRI apparatus of the horizontal magnetic field type according to the first embodiment.

FIG. 1B shows an external view of an MRI apparatus of the vertical magnetic field type according to the first embodiment.

FIG. 1C shows a tunnel type MRI apparatus according to the first embodiment.

FIG. 2 shows a configurational diagram of the MRI apparatus according to the first embodiment.

FIG. 3 shows an example of MRSI pulse sequence used in the first embodiment.

FIG. 4 shows drawings for explaining the region excited by an MRSI pulse sequence used in the first embodiment.

FIG. 5 shows an example of pre-pulse sequence used in the first embodiment.

FIG. 6 shows the process flow of the metabolite measurement used in the first embodiment.

FIG. 7 shows drawings for explaining the processing for obtaining a metabolite image used in the first embodiment.

FIG. 8 shows drawings for explaining the methods for defining the correction region and the measurement region used in the first embodiment.

FIG. 9 shows the process flow of the imaging processing used in the first embodiment.

FIG. 10A shows drawings for explaining the water signal suppression effect of the first embodiment showing a spectrum obtained by irradiating only RFC(+).

FIG. 10B shows drawings for explaining the water signal suppression effect of the first embodiment showing a spectrum obtained by irradiating RFC(+) and RFC(−).

FIG. 11A shows drawings for explaining the eddy current correction effect of the first embodiment showing a spectrum obtained without carrying out eddy current correction.

FIG. 11B shows drawings for explaining the eddy current correction effect of the first embodiment showing a spectrum obtained with performing eddy current correction.

FIG. 12 shows an example of the oscillating gradient magnetic field type high-speed MRSI pulse sequence used in the second embodiment.

FIG. 13 shows drawings for explaining the processing for obtaining a metabolite image used in the second embodiment.

### BEST MODE FOR CARRYING OUT THE INVENTION

### First Embodiment

Hereafter, the first embodiment of the present invention will explained with reference to drawings. This embodiment will be explained below by exemplifying a case where water signals are removed, and phase data for eddy current correction are obtained by using water signals. The signals which are removed or used for obtaining the phase data for eddy current correction are not limited to water signals, and they may be signals of a fat or the like.

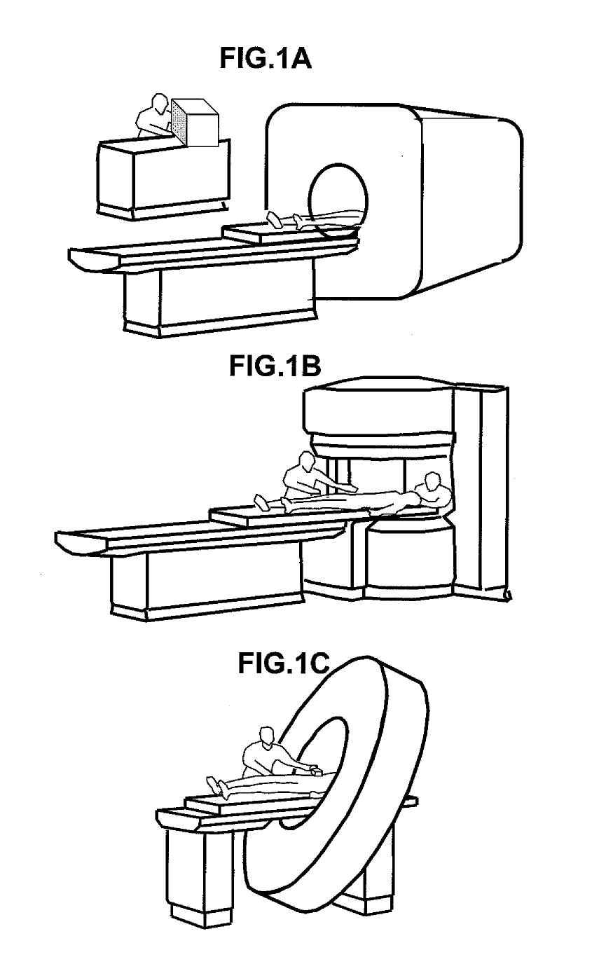

FIG. 1A to FIG. 1C are drawings showing total configurations and external views of exemplary nuclear magnetic resonance imaging (MRI) apparatuses according to this embodiment. FIG. 1A shows an MRI apparatus of the horizontal magnetic field type utilizing a tunnel-shaped magnet that generates a static magnetic field with a solenoid coil. FIG. 1B shows an MRI apparatus of the vertical magnetic field type utilizing a hamburger type (open type) magnet comprising separated upper and lower magnets in order to increase spaciousness. Further, FIG. 1C shows a tunnel type MRI apparatus similar to that of FIG. 1A, but depth of the magnet is shortened and the magnet is leaned to increase spaciousness. The MRI apparatus according to this embodiment is not limited to these apparatuses, and various kinds of MRI apparatuses can be used regardless of form or type thereof.

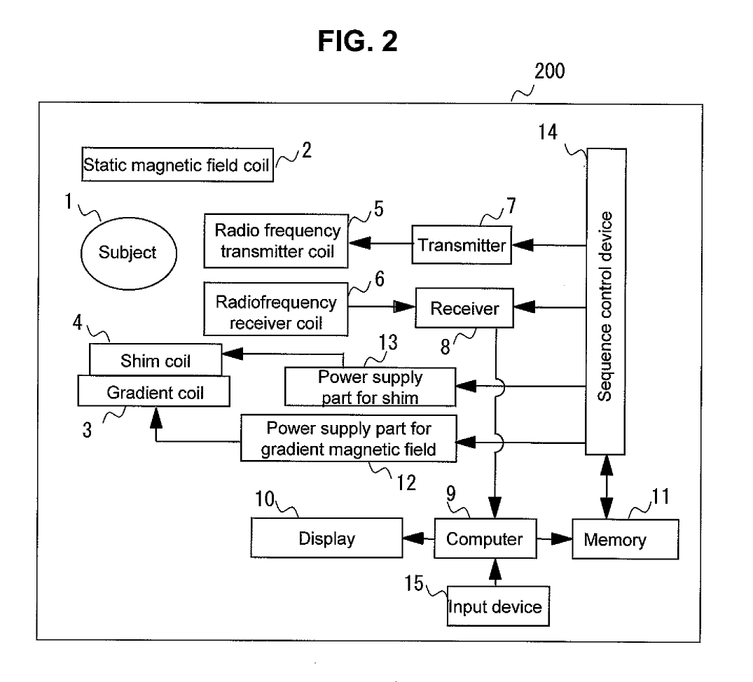

FIG. 2 shows configuration of an MRI apparatus 200 according to this embodiment. The MRI apparatus 200 according to this embodiment is provided with a static magnetic field coil 2 which generates a static magnetic field in a space in which a subject 1 is placed, a gradient coil 3 for applying gradient magnetic fields for three directions perpendicular to the static magnetic field, a radio frequency transmitter coil 5 (henceforth referred to simply as transmitter coil) which irradiates a radio frequency magnetic field on a measurement region of the subject 1, and a radio frequency receiver coil 6 (henceforth referred to simply as receiver coil) which receives magnetic resonance signals generated from the subject 1. The apparatus may further be provided with a shim coil 4 for adjusting homogeneity of the static magnetic field.

As the static magnetic field coil 2, those having various forms are employed according to the structure of the apparatus shows in FIG. 1. The gradient coil 3 and the shim coil 4 are driven by the power supply part 12 for gradient magnetic field and the power supply part 13 for shim, respectively. Although the transmitter coil 5 and the receiver coil 6 are separately shown in FIG. 2, only one radio frequency coil serving as both transmitter and receiver may also be used. The radio frequency magnetic field irradiated by the transmitter coil 5 is generated by the transmitter 7. The magnetic resonance signals detected by the receiver coil 6 are sent to a computer 9 via a receiver 8.

CPU of the computer 9 executes a program stored in a memory or the like to perform various operational processings of the magnetic resonance signals and thereby generate spectrum information and image information. In this embodiment, in order to realize the above, the computer 9 is provided with an image reconstruction processing part which reconstructs an image from k-space data and removes unnecessary signals, a correction value calculation processing part which calculates phase data for correcting influence of an eddy current, and a pulse intensity determination processing part which determines two kinds of intensities, i.e., flip angles, of the frequency-selective pulses generated by the transmitter 7. The frequency selective pulses are radio frequency magnetic field pulses applied by the pre-pulse sequence described later. The apparatus may be configured so that the function of the pulse intensity determination processing part should be realized by a computer separate from an MRI apparatus 100.

A display 10, a memory 11, an input device 15, and so forth are connected to the computer 9. The computer 9 executes processings for displaying spectrum information or image information on the display 10, recording the information in the memory 11, and so forth. The input device 15 is for inputting measurement conditions, conditions required for the operational processings, etc., and these are also recorded in the memory 11 as required. The flip angles of two frequency-selective pulses determined by the pulse intensity determination processing part are also recorded in the memory 11.

A sequence control device 14 controls the power supply part 12 for driving the gradient magnetic field generating coil 3, the power supply part 13 for shim for the shim coil 4, the transmitter 7, and the receiver 8. A time chart (pulse sequence) of the control is determined beforehand according to the imaging method, and is stored in the memory 11. In this embodiment, a pre-pulse sequence for generating only water signals at a predetermined intensity, and a pulse sequence for region selection type MRSI for imaging a metabolite (henceforth referred to as MRSI pulse sequence) are stored in the memory 11. The sequence control device 14 executes these two kinds of pulse sequences in combination using the measurement conditions inputted through the input device 15 and the intensities of the frequency-selective pulses determined by the pulse intensity determination processing part.

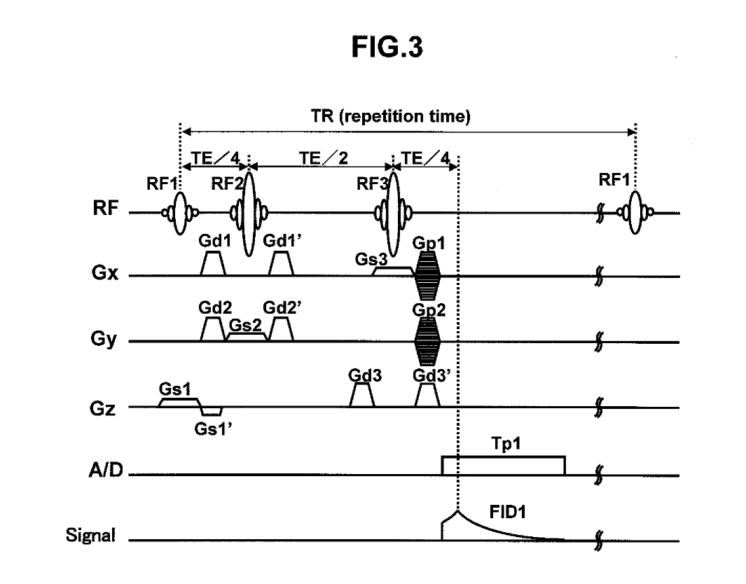

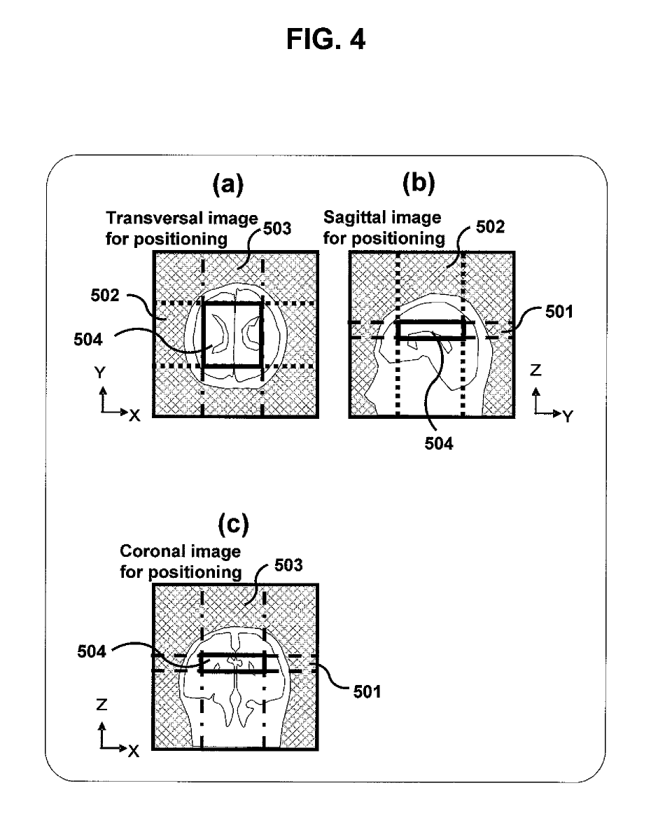

An example of the MRSI pulse sequence used in this embodiment is shown in FIG. 3. In FIG. 3, RF indicates application timings of a high frequency magnetic field pulse. Gx, Gy, and Gz indicate application timings of the gradient magnetic field pulses for the directions of x, y, and z, respectively. A/D indicates a signal measurement period. The MRSI pulse sequence shown in FIG. 3 is the same as known MRSI pulse sequences. This MRSI pulse sequence selectively excites a predetermined region of interest with one excitation pulse RF1 and two inversion pulses RF2 and RF3, so as to obtain an FID signal (free induction decay) FID1 from this region of interest. The region excited by this pulse sequence is shown in FIG. 4.

The operation performed with the MRSI pulse sequence of FIG. 3 is briefly explained with reference to FIG. 4. FIGS. 4, (a), (b), and (c) are transversal image, sagittal image, and coronal image for positioning, respectively. The radio frequency magnetic field pulse RF1 as an excitation pulse and the gradient magnetic field pulses Gs1 and Gs1′ are applied first to excite a section 501 for the z-direction. Then, at the time of TE/4 (TE is an echo time), the radio frequency magnetic field pulse RF2 as an inversion pulse and the gradient magnetic field Gs2 are applied to reverse only the phase of the nuclear magnetization in the region where the section 501 for the z-direction and the section 502 for the y-direction intersect. Then, at the time of TE/2 after the application of the radio frequency magnetic field pulse RF2, the radio frequency magnetic field pulse RF3 as an inversion pulse and the gradient magnetic field Gs3 are applied to reverse only the phase of the nuclear magnetization in the region of interest 504 where the section 501 for the z-direction, the section 502 for the y-direction and the section 503 for the x-direction intersect, and a free induction decay signal FID1 is measured.

The gradient magnetic fields Gd1 to Gd3 and the gradient magnetic fields Gd1′ to Gd3′ are gradient magnetic fields for dephasing the phase of the nuclear magnetization excited by the radio frequency magnetic field pulses RF2 and RF3, which do not disturb the phase of the nuclear magnetization excited by the radio frequency magnetic field pulse RF1. Further, after the application of the radio frequency magnetic field pulse RF3, the phase encoding gradient magnetic fields Gp1 and Gp2 are applied. Intensities of these phase encoding gradient magnetic fields Gp1 and Gp2 are changed for every one excitation to add positional information to the magnetic resonance signals generated from the region of interest 504. In this embodiment, if Gp1 is changed N1 times, and Gp2 is changed N2 times, for example, Gp2 is changed N2 times whenever Gp1 is changed once. Therefore, in the whole measurement, they are each changed N1×N2 times. Then, Fourier transform on the measured magnetic resonance signals FID1 is performed to obtain a distribution image of each metabolite contained in the region of interest 504 shown in FIG. 4.

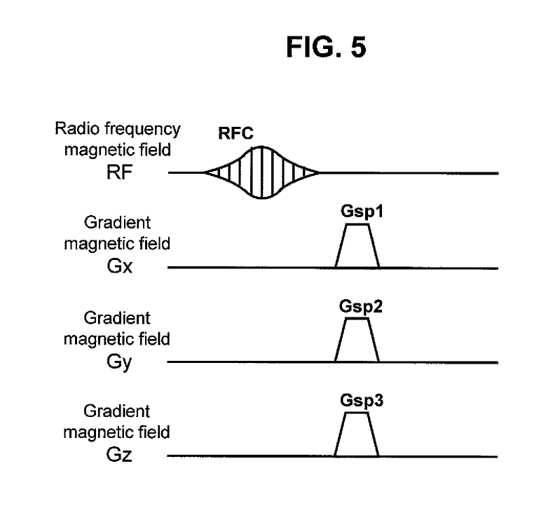

The pre-pulse sequence will be explained below. An example of the pre-pulse sequence used in this embodiment is shown in FIG. 5. The pre-pulse sequence is a sequence to be executed prior to the MRSI pulse sequence, and it is a sequence for changing polarity of water signals for every step of the phase encoding and modulating the water signals with the highest spatial frequency in the k-space in the following MRSI pulse sequence. In this embodiment, a radio frequency magnetic field pulse RFC which excites only the nuclear magnetization contained in water is irradiated as a frequency-selective pulse. As the radio frequency magnetic field pulse RFC, either one of a frequency-selective pulse RFC(+) which makes polarity of the water signals positive or a frequency-selective pulse RFC(−) which makes polarity of the water signals negative is irradiated for every phase encoding step with the following MRSI pulse sequence. In this case, absolute values of intensities of the water signals are the same.

As the frequency-selective pulses RFC(+) and RFC(−), which excite only the nuclear magnetization contained in water, a Gaussian radio frequency magnetic field pulse having a center frequency corresponding to the water resonance frequency and a narrowed excitation band (about 1.0 ppm) is used. After the irradiation of the radio frequency magnetic field pulse RFC, any one or all of spoiler gradient magnetic fields Gsp1 to Gsp3 for the x-axis, y-axis and z-axis directions are applied.

Further, each of the flip angles of the frequency-selective pulses RFC(+) and RFC(−) to be irradiated is determined by the pulse intensity determination processing part. The pulse intensity determination processing part determines a flip angle of one of the frequency-selective pulses so that only the nuclear magnetization contained in water should be excited at a predetermined intensity. Further, the flip angle of the other frequency-selective pulse is determined so that the absolute value of the intensity of the water signal obtained with the other frequency-selective pulse should be equal to the absolute value of the intensity obtained with the frequency-selective pulse of the previously determined flip angle, and polarities thereof should be opposite to each other, i.e., positive and negative. Although this embodiment is explained with reference to an example in which the frequency-selective pulses are irradiated once, they may be controlled by the method mentioned above and irradiated two or more times.

The water signals are intensity-modulated with two of the frequency-selective pulses RFC(+) and RFC(−), of which flip angles are determined as described above, for every phase encoding. The water signals obtained by excitation with such frequency-selective pulses RFC(+) and RFC(−) appear as aliasing at both ends of a correction region in a reconstituted image in the real space obtained by performing Fourier transform on the measured data. In this embodiment, unnecessary signals aliased at the both ends of the image in the real space are removed to suppress the water signals. On the other hand, the obtained measured data contain water signals. Therefore, in this embodiment, phase values are calculated from these measured data, and used for eddy current correction. The measurement which uses the pre-pulse sequences and the MRSI pulse sequence of this embodiment in combination for obtaining such measured data will be henceforth referred to as metabolite measurement, and the details thereof will be explained below.

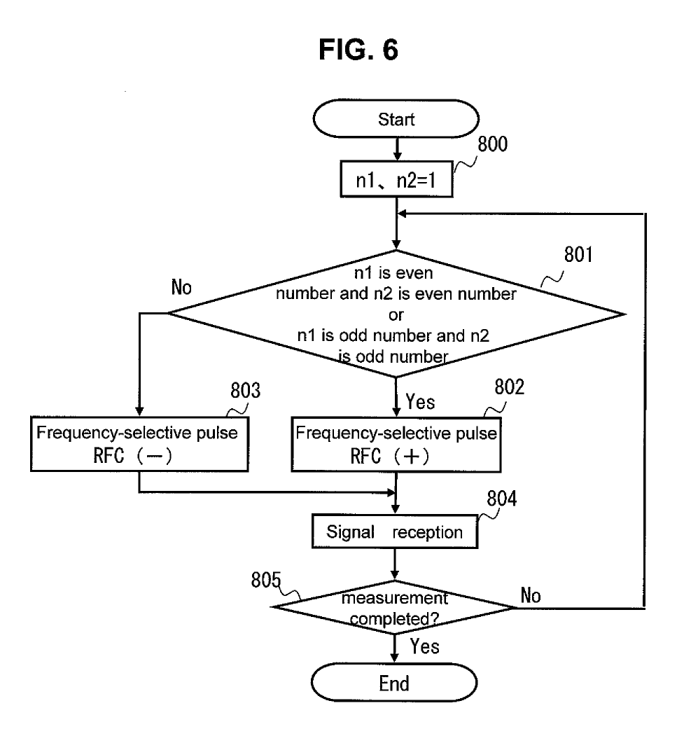

FIG. 6 shows a process flow of the metabolite measurement according to this embodiment. Hereafter, this embodiment will be explained with reference to an example where, when gradient magnetic fields of n1-th and n2-th intensities are applied as the phase encoding gradient magnetic fields Gp1 and GP2 of the immediately following MRSI pulse sequence (when the n1-th and n2-th steps are executed in the phase encoding Gp1 and Gp2, respectively), if both n1 and n2 are even numbers or odd numbers, the frequency-selective pulse RFC(+) is irradiated in the pre-pulse sequence, and otherwise, the frequency-selective pulse RFC(−) is irradiated in the pre-pulse sequence. That is, when (n1, n2)=(even number, even number) or (odd number, odd number), RFC(+) is irradiated, and otherwise, RFC(−) is irradiated. The total numbers of the steps executed in the phase encoding Gp1 and GP2 are represented by N1 and N2, respectively. n1, n2, N1, and N2 are natural numbers, and they satisfy n1≦N1 and n2≦N2. The combination of the frequency-selective pulses RFC(+) and RFC(−) to be irradiated is not limited to those mentioned above. Further, it is sufficient that the sign of the polarity of water signal (positive/negative) changes for every measurement point in the k-space, and so long as the measurement can be performed at all the measurement points in the k-space with the aforementioned combination, order of the steps of the phase encoding is not limited.

First, the sequence control device 14 initializes n1 and n2 (n1=1, n2=1, Step 800). Then, the sequence control device 14 determines whether the combination of the number of steps n1 of the phase encoding Gp1 and the number of steps n2 of the phase encoding Gp2 (n1, n2) corresponds to (even number, even number) or (odd number, odd number), or not (Step 801). When the combination is (even number, even number) or (odd number, odd number), a pre-pulse sequence is executed with the frequency-selective pulse RFC(+) as the radio frequency magnetic field pulse RFC, and then the MRSI pulse sequence is executed (Step 802). Otherwise, a pre-pulse sequence is executed with the frequency-selective pulse RFC(−) as the radio frequency magnetic field pulse RFC, and then the MRSI pulse sequence is executed (Step 803).

After the sequence control device 14 receives a signal (Step 804), and arranges it in the k-space, it determines whether the measurement has completed (Step 805) or not. Specifically, it determines whether n1=N1 and n2=N2 are satisfied or not. If it determines that the measurement is not ended, the process returns to Step 801, and the metabolite measurement is continued with changing the amounts of the phase encoding gradient magnetic field Gp1 or Gp2 to be applied according to the pulse sequence. If it is determined that the conditions n1=N1 and n2=N2 are satisfied, the metabolite measurement is ended.

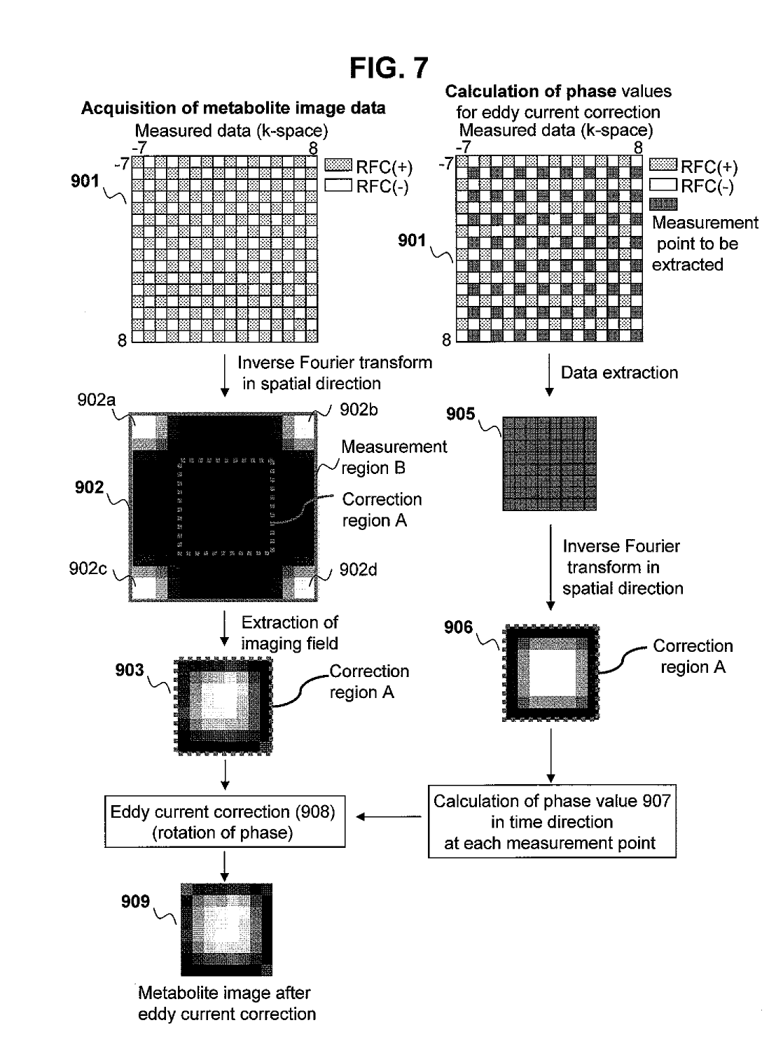

The measured data obtained by the metabolite measurement mentioned above and arranged in the k-space are shown in FIG. 7 as k-space data 901. FIG. 7 includes drawings for explaining the procedure of this embodiment for obtaining an image of a metabolite from the measured data, from which water signals are removed, and calculating phase values for correction. In the k-space data 901 obtained as a result of the metabolite measurement, the measured data obtained when the frequency-selective pulse RFC(+) was irradiated and the measured data obtained when the frequency-selective pulse RFC(−) was irradiated are alternately arranged in the k-space where the horizontal axis indicates the step N1 of the phase encoding Gp1, and the vertical axis indicates the step N2 of the phase encoding Gp2. In the drawings, those obtained by 16×16 matrix measurement is shown as an example. As shown in the drawing, the polarities of the water signals of the adjacent measurement points in the k-space are opposite to each other.

In this embodiment, the correction value calculation processing part calculates phase values 907 for eddy current correction from the k-space data 901. The image reconstruction processing part generates metabolite image data 903 in which water signal are removed, from the k-space data 901, and corrects influence of an eddy current in the metabolite image data 903 using the phase values 907 to obtain a metabolite image 909.

First, the processing for calculating the phase values for the eddy current correction, which is performed by the correction value calculation processing part, will be explained with reference to FIG. 7. The correction value calculation processing part uniformly extracts data in which water signals are intensity-modulated with the same polarity from the k-space data 901 in a number sufficient for constituting a correction region. In this embodiment, since the correction region corresponds to ¼ of the measurement region as described later, only the data obtained for the measurement points where both the steps of the phase encoding Gp1 and Gp2 are even-numbered steps, i.e., the measurement points of (n1, n2)=(even number, even number), are extracted from the k-space data 901, and arranged in a new k-space without changing the order of the data to obtain extracted data 905. Then, the extracted data 905 are subjected to Fourier transform and thereby converted into real space data 906. Size of these real space data 906 corresponds to that of the correction region, and they also contain water signals. Therefore, they have phase information including static magnetic field distortion caused by an eddy current. The correction value calculation processing part calculates phase values 907 for each measurement point for the time direction by using these real space data 906.

Although only the data obtained for the measurement points where the steps of the phase encoding Gp1 and Gp2 are even-numbered steps, i.e., the measurement points of (n1, n2) (even number, even number), are extracted from the k-space data 901 in the above explanation, the data to be extracted are not limited to such data. For example, data obtained for the measurement points where both the steps of the phase encoding Gp1 and Gp2 are odd-numbered steps may be extracted.

Hereafter, the processing of obtaining metabolite image data from the k-space data obtained in the aforementioned metabolite measurement and correcting influence of an eddy current to obtain an image, which is performed by the image reconstruction processing part, will be explained similarly with reference to FIG. 7.

The image reconstruction processing part performs Fourier transform on the k-space data 901 to obtain image data 902 in a real space. In the k-space data 901, water signals are intensity-modulated for every phase encoding with the frequency-selective pulses RFC(+) and RFC (−) having different flip angles as described above. The water signals generated by excitation with such frequency-selective pulses appear as aliasing at the both ends of the measurement region B in the image data 902 in the real space obtained as a result of the Fourier transform on the k-space data 901. In this embodiment, in the image data 902 of the real space, they appear as aliasing in the regions 902a, 902b, 902c, and 902d at the both ends. On the other hand, since the signals obtained from the metabolite are not intensity-modulated, they appear at usual positions in the measurement region B.

Therefore, by eliminating the regions 902a, 902b, 902c and 902d at the both ends where water signals appear, water signals can be substantially removed. In this embodiment, the image reconstruction processing part extracts a correction region A defined beforehand so as not to include the regions where water signals appear from the image data 902 of the real space to remove the regions 902a, 902b, 902c and 902d at the both ends. As a result, metabolite image data 903 within the correction region A are obtained. The procedure for defining the measurement region B and the correction region A so that the correction region A should not include water signals will be explained later.

Finally, the image reconstruction processing part corrects the obtained metabolite image data 903 by using the phase values 907 to obtain a metabolite image 909. Specifically, the metabolite image data 903 within the correction region A are complex multiplied with the phase values 907 to perform eddy current correction 908, and thereby obtain the corrected metabolite image 909.

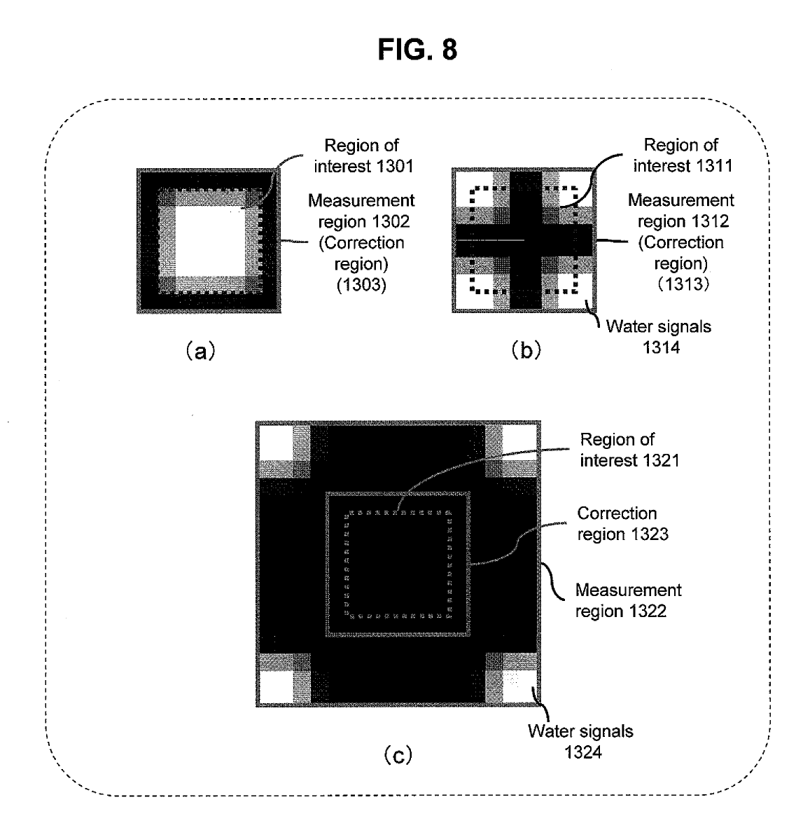

The method of defining the correction region A and the measurement region B in the case of removing water signals from the data 902 obtained by performing Fourier transform on the k-space data 901 by removing aliasing in the regions 902a, 902b, 902c, and 902d will be explained with reference to FIG. 8. FIG. 8 includes drawings for explaining the method for defining the correction region and the measurement region. FIGS. 8, (a) and (b) are drawings for the case where the measurement region corresponds to the imaging field, and FIG. 8, (c) is a drawing for explaining the case where the measurement region is re-defined in a size twice or more as large as the imaging field.

In the conventional MRSI measurement, the measurement region 1302 corresponds to the correction region 1303 as shown in FIG. 8, (a). In such a case, when a region of interest 1301 is larger than the measurement region 1302 (namely, correction region 1303), aliasing is generated in the image. In order to prevent generation of aliasing, the measurement region 1302 (correction region 1303) is defined to be larger than the region of interest 1301 as shown in FIG. 8, (a).

However, in this embodiment, as shown in FIG. 8, (b), even if the measurement region 1312 (correction region 1313) is defined to be larger than the region of interest 1311, water signals 1314 appear as aliasing at the ends of the measurement region 1312. Unless the measurement region 1312 (correction region 1313) is sufficiently larger than the region of interest 1311, the water signals 1314 aliased at the both ends of the measurement region 1312 are included in the region of interest 1311. In this embodiment, the measurement region 1332 is defined so that the water signals 1324 should not be included in the region of interest 1321, as shown in FIG. 8, (c).

In actual measurement, the size of the region of interest 1321 is decided beforehand, and therefore those that can be changed by changing parameters used upon execution of a pulse sequence are the measurement region 1322 and the correction region 1323. In this embodiment, the data for eddy current correction are obtained for the measurement points in the k-space alternately selected, and therefore the size of one side of the measurement region 1322 becomes twice as large as the size of one side of the correction region 1323. Moreover, it is necessary to define the correction region 1323 to be included in the region of interest 1321. If the size of one side of the region of interest 1321 is represented by A, the size of one side of the measurement region 1322 is represented by B, and the size of one side of the correction region 1323 is represented by C, the relationships of A, B and C are represented by the following equations (1), (2) and (3).

B=2×C (1)

C>A (2)

Namely,

B>2×A (3)

On the basis of the relationships mentioned above, in order for the water signals 1324 not to be aliased into the correction region 1323, one side of the measurement region 1322 can be defined to be twice or more as large as one side of the region of interest 1321.

Hereafter, the method for setting parameters in an MRSI pulse sequence for obtaining such a measurement region 1322 as described above will be explained for one axis direction. This explanation will be made on the basis of a definition that the measurement region 1322 has a length of a side for one axis direction m (m is a natural number of 2 or larger) times as large as the same of the correction region 1323.

When the measurement region 1302 corresponds to the correction region 1303, variation amount of phase encoding ΔGGP in the whole measurement space is represented by the following equation (4), wherein ΔGp represents variation amount of phase encoding Gp, and n represents number of steps of the phase encoding.

ΔGGP=ΔGp×n (4)

In this case, the length XX of the side for one axis direction of the correction region 1303, i.e., the measurement region 1302, is represented by the following equation (5), wherein k is a proportionality constant.

XX=k/ΔGp (5)

Further, the spatial resolution “x” of the measurement region 1302 is represented by the following equation (6), wherein k′ is a proportionality constant.

“x”=k′/ΔGGP (6)

In this embodiment, the measurement is performed in the measurement region 1322 having a length of the side for one axis direction m times as large as that of the correction region 1323 without changing spatial resolution as mentioned above. In this case, if variation amount of phase encoding in case that the measurement region 1322 and the correction region 1333 are in such a relation is represented by ΔGp′, phase encoding step is represented by n′, variation amount of phase encoding for the whole measurement space is represented by ΔGGP′, size of the measurement region 1322 for one axis direction is represented by XX′, and spatial resolution of the measurement region 1322 is represented by x′, relations of these are represented by the following equations (7), (8) and (9).

ΔGGP′=ΔGp′×n′ (7)

XX′=k/ΔGp′ (8)

x′=k′/ΔGGP′ (9)

Further, in order to make the length of the measurement region 1323 m times larger without changing spatial resolution, the conditions represented by the following equations (10) and (11) must be satisfied.

XX′=m×XX (10)

x′=“x” (11)

On the basis of the above conditions, ΔGp′ and n′ must satisfy the conditions represented by the following equations (12) and (13).

ΔGp′=ΔGp/m (12)

n′=m×n (13)

That is, the parameters of the MRSI pulse sequence are determined so that the variation amount of phase encoding ΔGp′ should become 1/m of the conventional magnitude, and a number of steps of n′ should become m-times oversampling. The parameters may be defined beforehand, or may be inputted by an operator immediately before the start of imaging.

By applying a phase encoding gradient magnetic field with the MRSI pulse sequence and performing sampling as described above, the length of one side of the measurement region 1322 becomes m times as large as that of the correction region 1322, aliasing of water signals does not enter into the correction region 1322, i.e., the region of interest 1321, and thus water signals can be easily removed from the image.

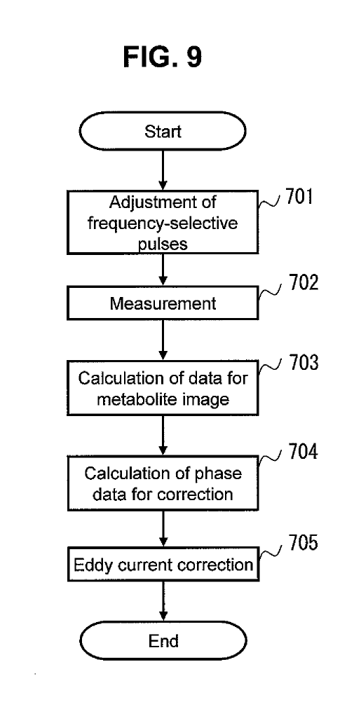

The imaging processing performed by the MRI apparatus 100 according to this embodiment and realized by the functions explained above will be explained. FIG. 9 shows a process flow of the imaging processing according to this embodiment. Hereafter, this embodiment will be explained with reference to a case where the flip angles of the frequency-selective pulses are determined immediately before the measurement at the time of imaging as an example. The flip angles of the frequency-selective pulses may not be determined immediately before the measurement, so long as they are determined before the measurement, and they may be determined beforehand.

The pulse intensity determination processing part adjusts and determines the flip angles of two frequency-selective pulses (Step 701). Then, it sends the results to the sequence control device 14. In this case, the flip angles of the frequency-selective pulses are adjusted and determined so that the absolute values of the intensities of water signals should be the same, and polarities should be opposite to each other, i.e., positive/negative, as described above.

The sequence control device 14 carries out metabolite measurement by using the flip angles of the frequency-selective pulses received from the pulse intensity determination processing part, and arranges data in a k-space (Step 702). The image reconstruction processing part calculates metabolite image data, in which water signals are removed, from the k-space data (Step 703). The correction value calculation processing part calculates phase values for eddy current correction from the k-space data (Step 704). The order of the processings of Step 703 and Step 704 is not limited.

The image reconstruction processing part corrects the metabolite image data by using the phase values calculated by the correction value calculation processing part in Step 704 to obtain a metabolite image (Step 705).

As explained above, according to this embodiment, water signals are intensity-modulated for every phase encoding with two frequency-selective pulses having different flip angles, and arranged in a k-space. By performing Fourier transform on the k-space data including water signals, and eliminating aliasing produced at both ends in a real space, water signals are removed. Further, data of a required number are extracted from the k-space data including water signals to calculate phase data for eddy current correction. Therefore, according to this embodiment, signals unnecessary for detecting a metabolite can be efficiently removed, and correction of an eddy current can also be performed, on the basis of results of a single measurement.

That is, according to this embodiment, data from which water signals unnecessary for detecting a metabolite can be easily removed, and phase data for correcting spectral distortion caused by an eddy current can be simultaneously obtained in the MRSI measurement. Therefore, a highly precise metabolite image can be quickly obtained.

According to this embodiment, it is not required to separately perform a measurement for obtaining phase data for eddy current correction, and therefore measurement time can be shortened compared with the conventional method. Moreover, with the same measurement time, SNR of an image can be improved by increasing the number of times of reception using time that has been conventionally used for the measurement for obtaining phase data for eddy current correction.

Although this embodiment has been explained by exemplifying a case where the frequency-selective pulses are modulated for every phase encoding for two axes, the modulation may be performed only for one axis. Further, when the image to be obtained is a three-dimensional image, the frequency-selective pulses may be modulated for every three axes, or modulation may be performed for only two axes or one axis.

### Example

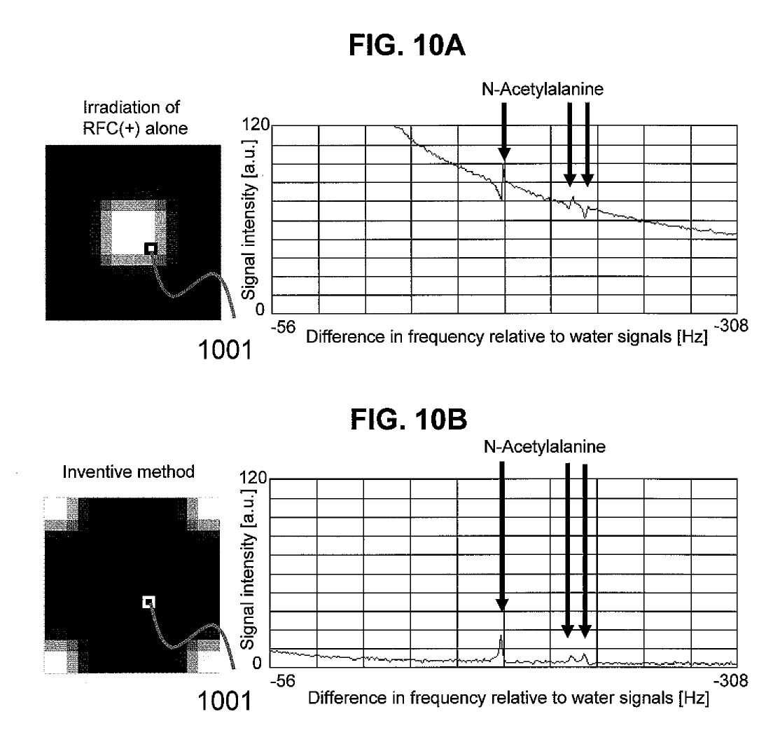

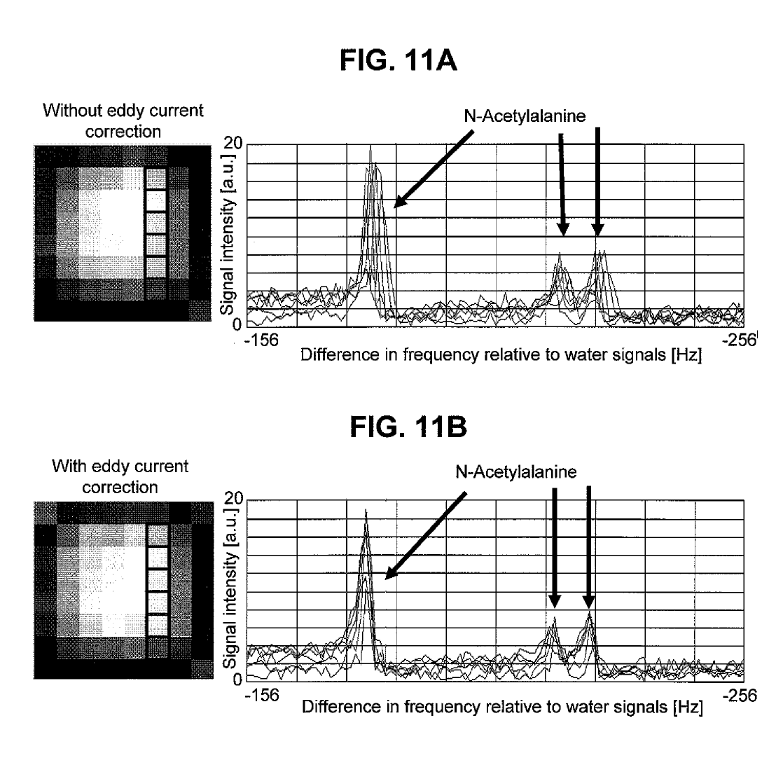

The water-suppression effect and the eddy current correction effect to be attained by the aforementioned embodiment will be explained with reference to a measurement experiment using an N-acetylalanine phantom. The results are shown in FIGS. 10A, 10B, 11A and 11B, respectively.

A spectrum for a specific measurement point 1001 of metabolite image data obtained by irradiating only a frequency-selective pulse RFC(+) as a radio frequency magnetic field pulse RFC in a pre-pulse sequence is shown in FIG. 10A. A spectrum for a specific measurement point 1001 of metabolite image data obtained by irradiating a frequency-selective pulse RFC(+) and a frequency-selective pulse RFC(−) according to the method of the aforementioned embodiment is shown in FIG. 10B.

In FIG. 10A, N-acetylalanine signals are buried in the large water signals. However, according to the method of the aforementioned embodiment, water signals in the region of interest markedly decreased as shown in FIG. 10B, and it can be seen that N-acetylalanine signals clearly appeared.

A spectrum of a metabolite image obtained by the method of the aforementioned embodiment, but not subjected to eddy current correction according to the method of the aforementioned embodiment is shown in FIG. 11A. A spectrum of a metabolite image subjected to eddy current correction using a part of the obtained data according to the method of the aforementioned embodiment is shown in FIG. 11B. It can be seen that the shift of the spectrum for the spatial direction is improved in FIG. 11B compared with FIG. 11A.

From the above results, it can be seen that water signals in a region of interest can be sufficiently removed, and eddy current correction can also be favorably performed by the method of the aforementioned embodiment.

Next, the measurement times of the method of the aforementioned embodiment and the conventional method are compared under the condition of the same SNR. The same numbers of times of reception are used in the method of the aforementioned embodiment and the conventional method in order to obtain the same SNR conditions with the same spatial resolution in the images to be obtained.

In this comparison, the number of times of signal integration is adjusted in the conventional method to obtain the same total number of times of reception as that of the method of the aforementioned embodiment. In the explanation described below, the correction region consists of 8×8 matrices.

In the aforementioned embodiment, if the modulation is performed for two axes of the phase encoding, at least twice lager oversampling is required in order to remove aliasing of water signals in the image. If twice lager oversampling is performed, MRSI measurement is performed for 16×16 matrices twice larger than 8×8 matrices. In this case, the number of times of signal reception is 256.

On the other hand, in the conventional method, the same SNR as that of the aforementioned embodiment can be obtained by performing the MRSI measurement of 8×8 matrices four times, i.e., performing signal integration 4 times, which results in the number of times of reception being 256. According to the conventional method, it is necessary to further obtain water signal data of the 8×8 matrices in order to obtain phase data for eddy current correction. That is, the number of times of reception increases by 64. In addition, since this measurement of water signals does not contribute to SNR of the main MRSI measurement, it just increases the total measurement time.

On the basis of the above consideration, if the measurement time of the conventional method is represented as 1, the measurement time of the aforementioned embodiment in the case of modulation for phase encoding for two axis is calculated to be 256/(256+64)=0.80, and thus can be shortened by 20%.

Next, effect of the aforementioned embodiment where the modulation is performed for phase encoding for one axis will be explained below. The correction region is defined to consist of 8×8 matrices as in the aforementioned case of modulation for phase encoding for two axes. In this case, modulation is performed for phase encoding for one axis, and oversampling is performed for a twice larger region in order to remove the aliasing of water signals in image.

In the aforementioned embodiment, oversampling is carried out for the phase encoding direction along which the modulation is performed in order to remove aliasing of water signals in image as described above. Therefore, under the conditions of this case, MRSI measurement is performed for, for example, 8×16 matrices. In this case, the number of times of signal reception is 128.

On the other hand, in the conventional method, if the MRSI measurement is performed twice for 8×8 matrices, i.e., number of times of signal integration is made twice, number of times of signal reception becomes 128, and thus the same SNR as that of the aforementioned embodiment can be obtained. In this case, in the conventional method, in order to obtain phase data for eddy current correction, it is necessary to further obtain water signal data of 8×8 matrices. That is, the number of times of reception increases by 64. On the basis of the above consideration, if the measurement time of the conventional method is represented as 1, the measurement time of the aforementioned embodiment in the case of modulation for phase encoding for one axis is calculated to be 128/(128+64)=0.67, and thus can be shortened by about 33%.

As described above, according to the aforementioned embodiment, it becomes possible to sufficiently remove water signals unnecessary for detection of a metabolite and simultaneously obtain phase data for eddy current correction in MRSI measurement, and thus a highly precise metabolite image can be quickly obtained.

### Second Embodiment

The second embodiment of the present invention will be explained below. The first embodiment has been explained with reference to a case where a basic MRSI pulse sequence is used for the measurement as an example. However, the pulse sequence used for the main measurement is not limited to such a sequence. For example, pulse sequences of the FSE type for high-speed MRSI, and those for oscillating gradient magnetic field type high-speed MRSI can also be used. Hereafter, this embodiment will be explained with reference to a case where an oscillating gradient magnetic field type high-speed MRSI pulse sequence is used for the main measurement as an example. The MRI apparatus used in this embodiment is basically the same as that used for the first embodiment. Hereafter, this embodiment will be explained with focusing configurations different from those of the first embodiment.

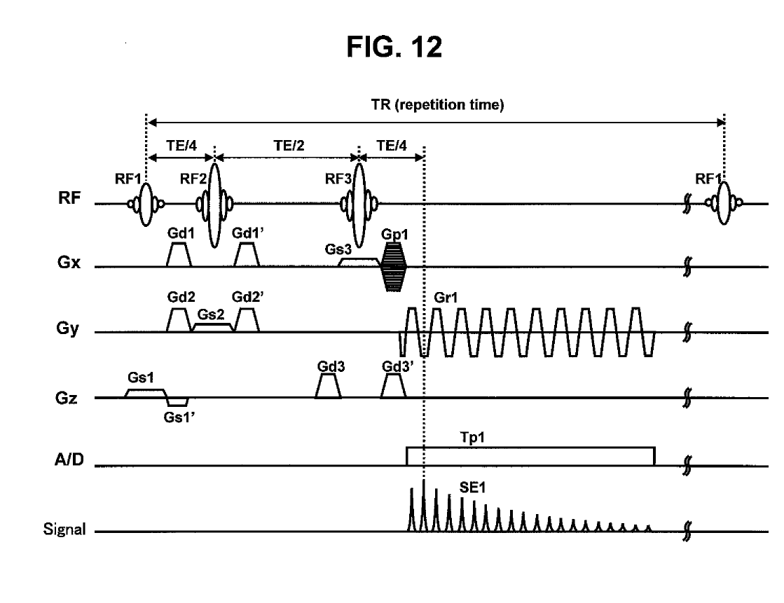

FIG. 12 shows an example of the oscillating gradient magnetic field type high-speed MRSI sequence used in this embodiment. The gradient magnetic field type high-speed MRSI pulse sequence shown in this drawing is the same as known oscillating gradient magnetic field type high-speed MRSI sequences. In this oscillating gradient magnetic field type high-speed MRSI pulse sequence, an oscillating gradient magnetic field Gr1 is applied instead of the phase encoding gradient magnetic field Gp2 of the MRSI pulse sequence shown in FIG. 3. By receiving signals with applying the oscillating gradient magnetic field Gr1, signals SE1 frequency-encoded along the application axis direction are obtained as time series data.

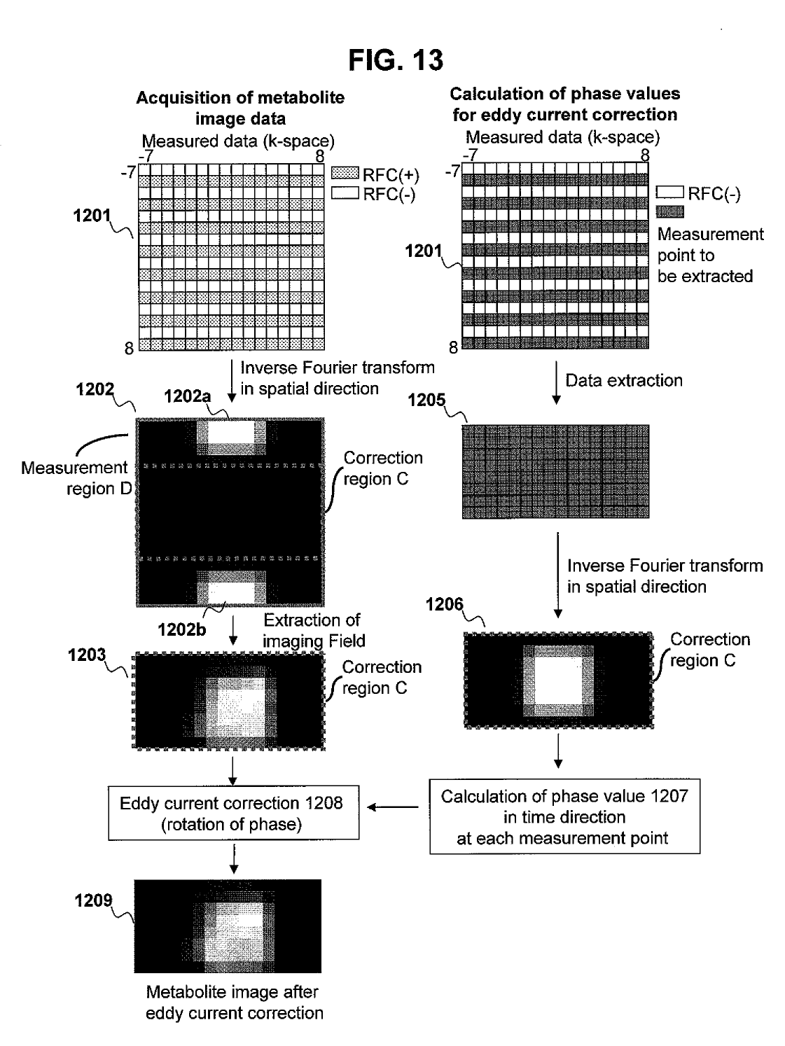

The process flow of the imaging processing according to this embodiment is basically the same as that shown in FIG. 9. However, since the modulation for phase encoding is performed for one axis, processings of Step 702 to Step 705 are different. Hereafter, Steps 702 to 705 of this embodiment shown in FIG. 9 will be explained in detail with reference to FIG. 13.

First, processings different from those of the first embodiment will be explained for the metabolite measurement of Step 702. In the oscillating gradient magnetic field type high-speed MRSI pulse sequence shown in FIG. 12, the total number of steps of phase encoding Gp1 is represented by N1. In this case, n1-th (n1≦N1) phase encoding is executed following a pre-pulse sequence.

When n1 is an even number, the frequency-selective pulse RFC(+) is irradiated as a radio frequency magnetic field pulse RFC prior to the execution of the MRSI pulse sequence. When n1 takes a number otherwise, RFC(−) is irradiated. Then, signals are received with applying oscillating gradient magnetic field Gr1, and this operation is repeated until the measurement is completed, i.e., until n1 reaches N1. When n1 is an odd number, the frequency-selective pulse RFC(−) may be irradiated prior to the execution of the MRSI pulse sequence, and when n1 takes a number otherwise, RFC(+) may be irradiated.

The measured data obtained by these measurements and arranged in k-space are shown in FIG. 13 as k-space data 1201. FIG. 13 comprises drawings for explaining the procedure of this embodiment for obtaining an image of a metabolite, in which water signals are removed, from the measured data, and calculating phase values for correction. As shown in the drawings, in the k-space data 1201 obtained as a result of the metabolite measurement, the measured data obtained when the frequency-selective pulse RFC(+) was irradiated and the measured data obtained when the frequency-selective pulse RFC(−) was irradiated are alternately arranged in the k-space where the horizontal axis indicates the step N1 of the phase encoding Gp1, and the vertical axis indicates the step N2 of the phase encoding Gp2. In the drawings, 16×16 matrix measurement is shown as an example.

Hereafter, the processing of this embodiment for calculating the metabolite image data, which is performed by the image reconstruction processing part in Step 703 shown in FIG. 9, will be explained with reference to FIG. 13. In this embodiment, performing Fourier transform on the k-space data 1201 obtained by the metabolite measurement is performed to obtain image data 1202 in a real space. In this case, water signals in the k-space data 1201 are intensity-modulated with the frequency-selective pulses RFC(+) and RFC(−) having different flip angles for every phase encoding for one axis direction. Therefore, they appear as aliasing in the region of 1202a and 1202b of the image data 1202 in the real space at the both ends in the direction along which water signals are modulated. On the other hand, since signals of a metabolite are not intensity-modulated, they appear at usual positions in the measurement region D.

Therefore, by removing the regions 1202a and 1202b at the both ends where water signals appear, water signals can be substantially removed. Also in this embodiment, the image reconstruction processing part extracts a correction region C defined so as not to include any region where water signals appear from the image data 1202 of a real space to remove the regions 1202a and 1202b at the both ends. As a result, metabolite image data 1203 within the correction region C are obtained. The methods of this embodiment for defining the correction region C and the measurement region D are basically the same as those of the first embodiment, and they are defined so that one side of the measurement region D should be twice or more as large as one side of the correction region C for the axis direction along which water signals are modulated.

Hereafter, the processing of calculating the phase values for the eddy current correction performed by the correction value calculation processing part in Step 704 shown in FIG. 9 will be explained similarly with reference to FIG. 13.

Also in this embodiment, the correction value calculation processing part uniformly extracts the data in which water signals are intensity-modulated with the same polarity from the k-space data 1202 in a number sufficient for constituting a correction region, as in the first embodiment. In this embodiment, since the correction region corresponds to ½ of the measurement region, only the data obtained for the measurement points where the steps of the phase encoding Gp1 are even-numbered steps, i.e., the measurement points of n1=even number, are extracted from the k-space data 1201, and arranged in a new k-space without changing the order of the data to obtain extracted data 1205. Then, the extracted data 1205 are subjected to Fourier transform and thereby converted into real space data 1206. Size of these real space data 1206 corresponds to that of the correction region C, and they also include water signals. Therefore, they have phase information including static magnetic field distortion caused by an eddy current. The correction value calculation processing part calculates phase values 1207 for each measurement point for the direction of time by using these real space data 1206.

Then, also in this embodiment, the image reconstruction processing part complex multiplies the metabolite image data 1203 within the correction region C with the phase values 1207 in Step 705 shown in FIG. 9, as in the first embodiment, to perform eddy current correction 1208 and thereby obtain a corrected metabolite image 1209.

As explained above, also in this embodiment, data from which water signals unnecessary for detecting a metabolite can be easily removed, and phase data for correcting spectral distortion caused by an eddy current can be simultaneously obtained in the MRSI measurement. Therefore, a highly precise metabolite image can be quickly obtained. According to this embodiment, the mode of the measurement is the same as that used with modulation for phase encoding for one axis, the measurement time can be shortened to 66% of the measurement time of the conventional method as described above.

Further, when the image to be obtained is a three-dimensional image, the frequency-selective pulses may be modulated for every two axes or one axis.

### DENOTATION OF REFERENCE NUMERALS

2: Static magnetic field coil, 3: gradient coil, 4: shim coil, 5: transmitter coil, 6: receiver coil, 7: transmitter, 8: receiver, 9: computer, 10: display, 11: memory, 12: power supply part for gradient magnetic field, 13: power supply part for shim, 14: sequence control device, and 15: input device

1. A magnetic resonance imaging apparatus comprising a radio frequency magnetic field pulse irradiation means for irradiating a radio frequency magnetic field pulse on a subject placed in a static magnetic field space, a gradient magnetic field application means for applying a gradient magnetic field for adding spatial information, a detection means for detecting nuclear magnetic resonance signals generated from the subject, a control means for controlling operations of the radio frequency magnetic field pulse irradiation means, the gradient magnetic field application means, and the detection means, and an image reconstruction means for reconstructing an image from the magnetic resonance signals detected by the detection means, wherein:
the control means controls the operations so as to perform magnetic resonance spectroscopic imaging (MRSI) measurement, executes a pre-pulse sequence for applying a frequency selective pulse for carrying out intensity modulation of signals from unnecessary substances as unnecessary signals for every phase encoding in the MRSI measurement prior to the MRSI measurement, and arranges the signals detected by the detection means in a measurement space as measured data, and
the image reconstruction means
comprises a correction data calculation means for calculating data for correction using a part of the measured data arranged in the measurement space, and
corrects image data obtained by removing the unnecessary signals from the measured data arranged in the measurement space using the correction data.

2. The magnetic resonance imaging apparatus according to claim 1, wherein:
the apparatus further comprises a pulse intensity determination means for determining such two kinds of flip angles that the unnecessary signals should have equal absolute values of signal intensity and opposite positive and negative polarities as flip angles of the frequency-selective pulse.

3. The magnetic resonance imaging apparatus according to claim 2, wherein:
the control means operates to alternately apply the two kinds of frequency-selective pulses for every phase encoding for at least one axis in the MRSI measurement.

4. The magnetic resonance imaging apparatus according to claim 1, wherein:
the control means controls the gradient magnetic field application means so that the measurement should be performed with the same spatial resolution for a region corresponding to m times (m is a natural number of 2 or larger) of a correction region for at least one direction along which the gradient magnetic field is applied, and
the image reconstruction means obtains the image data by removing m/2 of the data from each of both ends for the direction along which the range of the measurement points are expanded by m times.

5. The magnetic resonance imaging apparatus according to claim 4, wherein:
the control means controls the gradient magnetic field application means so that the measurement should be performed with variation amount of phase encoding corresponding to 1/m of that for measuring the same region as the correction region, and a number of steps of the phase encoding corresponding m times of that for measuring the same region as the correction region for at least one direction along which the gradient magnetic field is applied.

6. The magnetic resonance imaging apparatus according to claim 2, wherein:
the correction data calculation means extracts measured data in a number required for constituting a correction region of the same size as that of the image data from the measured data obtained by applying the frequency-selective pulse of the same flip angle, and calculates data for correction by using the extracted measured data.

7. The magnetic resonance imaging apparatus according to claim 6, wherein:
the data for correction are phase data for correcting influence of an eddy current.

8. The magnetic resonance imaging apparatus according to claim 1, wherein:
the MRSI measurement comprises application of a phase encoding gradient magnetic field for at least one axis.

9. The magnetic resonance imaging apparatus according to claim 1, wherein:
the MRSI measurement comprises application of a phase encoding gradient magnetic field for at least one axis, and application of an oscillating gradient magnetic field perpendicular to the axis.

10. The magnetic resonance imaging apparatus according to claim 1, wherein:
the image reconstruction means removes the unnecessary signals by aliasing the unnecessary signals to both ends in the image data in the real space obtained by performing Fourier transform on the measured data arranged in the measurement space, and removing the aliasing parts.
